(19) United States
(12) Patent Application Publication
(10) Pub. No.: US 2008/0129774 A1
(43) Pub. Date: Jun. 5, 2008

(54) PRINTER CAPABLE OF CORRECTING PRINTING DEVIATION USING ONE-WAY PRINTING AND METHOD FOR THE SAME

(76) Inventors: Cheng-Lung Lee, Taipei City (TW); Sheng-Lung Tsai, Ping-Tung County (TW); Po-Chin Yang, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/947,783

(22) Filed: Nov. 30, 2007

(30) Foreign Application Priority Data
Nov. 30, 2006 (TW) 095144484

(51) Int. Cl. B41J 29/393

(52) U.S. Cl. 347/19

(57) ABSTRACT

A printer performs one-way printing for outputting a test pattern as an actual pattern having printing deviation. An optical detector then scans the actual pattern in the same direction as the actual pattern is outputted and transforms the scanning result into a correlation diagram of a distance to the light reflection rate. A one-way deviation amount can be obtained and taken as a position adjustment value of the one-way printing by comparing the curve in the correlation diagram with a reference point. The forward printing deviation and the backward printing deviation of the printer can be corrected respectively when confronting inaccurate correction due to printhead jamming.

### BACKGROUND OF THE INVENTION

1. Field of the Invention

The present invention relates to a printer and a correcting method, and more specifically, to a printer capable of correcting printing deviation using one-way printing and method for the same.

2. Description of the Prior Art

In a modern printer, a DC motor drives the printhead to move back and forth on a printing medium for printing. To raise the printing efficiency, most printheads print bidirectionally on the printing medium. When an ink drop is heated and ejected out of the printhead, the moving direction of the ink drop is determined by the moving direction and moving speed of the printhead. Generally, any ink drop is not dropping on the predetermined place above where it is ejected. Additionally, different moving direction and moving speed of the printhead lead to different dropping positions of an ink drop. Please refer to FIG. 1. FIG. 1 is an illustration of moving speed of a printhead 10 and ink drop 12 according to the prior art. The X-axis stands for the moving direction of the printhead 10, the Y-axis stands for the dropping direction of the ink drop 12, the moving speed of the printhead 10 is Vp, the speed of the ink drop 12 ejected from the printhead 10 is Vd, and V is the combined speed of Vp and Vd, i.e. the actual moving speed of the ink drop 12. θ is the included angle of V and Vd, S is the distance between the nozzle of the printhead and the printing medium, and d is the distance between a default dropping position and an actual dropping position of the ink drop 12, which can be expressed as the following equation:

d=S tan θ=S(Vp/Vd);

Therefore, if θ is a fixed angle, then d is a fixed value. FIG. 2 is an illustration of a correlation diagram of the default position O and actual position (for forward printing f and backward printing b) of an ink drop 12 when the printhead 10 prints bidirectionally according to the prior art. The distances between f and O and between b and O are both d.

In order to correct bidirectional deviation, the printer first outputs a pattern with known disposition bidirectionally on a printing medium with a fixed speed as FIG. 3 shows. FIG. 3 is an illustration of a test pattern for adjusting bidirectional deviation according to the prior art. Each check block 14 has a width of W and separates from each other with a distance W. Check blocks 14 with numbers 1, 3, and 5 are printed sequentially in forward printing and check blocks 14 with numbers 6, 4, and 2 are printed sequentially in backward printing. Since the ink drops deviate their dropping position, the actual disposition of the pattern printed on the print medium differs from the default disposition. FIG. 4 is an illustration of the actual output of the test pattern in FIG. 3 wherein the dashed rectangles represent the test pattern in FIG. 3, d is the actual deviation of the ink drop 12 in FIG. 1. FIG. 5 is an illustration of an optical detector 20 movable with the printhead according to the prior art for scanning the printing pattern in FIG. 4. The optical detector 20 comprises an emitter 22 and a receiver 24 for receiving lights reflected from the printing medium 26. When the emitter 22 emits lights on the printing medium 26, lights will reflect from the printing medium with different energies according to the shading level of the illuminated area. The receiver 24 can generate voltage signals corresponding to the energy of light reflected from the print medium 26. Hence, the optical detector 20 can obtain the actual printing position and compare with the default print position for the printing deviation. Finally the printing deviation of bidirectional printing is corrected by compensating the obtained printing deviation. Please refer to FIG. 6. FIG. 6 is an illustration of a correlation diagram of the distance to the light reflection rate corresponding to the output in FIG. 4 using the optical detector 20 in FIG. 5. Because the white areas have higher light reflection rate, the receiver 24 receives more lights and the optical detector 20 outputs larger voltage signals. When the optical detector 20 scans through the check block 14, the output voltage decreases with the increase of the black proportion in the coverage. When the coverage of the optical detector 20 lies totally on the check block 14, the position in FIG. 6 shows a lowest light reflection rate.

The deviation caused by bidirectional printing can be obtained by measuring the distance between each two adjacent minimum points of the curve in FIG. 6. The distance between each two adjacent minimum points represents the distance between two adjacent check blocks 14 in FIG. 4. For example, the distance M between the check blocks 1 and 2 in FIG. 4 is W−2d and the distance N between the check blocks 2 and 3 in FIG. 4 is W+2d. The calculated bidirectional deviation according to the prior art is (N−M)/2=2d and the printhead is corrected by half of the calculated bidirectional deviation, or d to eliminate the bidirectional deviation.

When the prior art performs compensation of bidirectional deviation, if the printhead used for outputting the pattern is defect such as nozzle jamming, ink drops won't be ejected steadily and the scan result of the optical detector has a dissatisfactory accuracy. In FIG. 7, the defect of the printhead results a distance M smaller than W−2d between the actual blocks 15 number 1 and 2 while the distance N between the actual blocks 15 number 2 and remains W+2d. The bidirectional deviation (N−M)/2 calculated according to the prior art correction method is larger than 2d, resulting a larger position adjustment value d′ than d, which deteriorates the correction result since the optical detector 20 obtains inaccurate scanning result.

### SUMMARY OF THE INVENTION

The present invention provides a method for adjusting a position where an actual pattern is printed by a printhead. The method comprises steps of defining a test pattern having a predetermined distance away from a reference point; printing the an actual pattern on a printing medium based on the test pattern when the printhead moves in a direction from a first end toward a second end; scanning the actual pattern by an optical detector moving in the same direction as the printhead moves; determining an actual distance between the reference point and actual pattern from the scanning result of the optical detector; and updating the position where the printhead starts printing when the printhead moves from the first end toward the second end according to difference between the actual distance and the predetermined distance.

The present invention also provides a method for correcting a printer storing a first check pattern having a first left edge. The first left edge is separate by a reference point from a first predetermined distance. The method comprises steps of driving a printhead moving from left to right to print the first check pattern onto a medium, the printed first check pattern having a first left printing edge corresponding to the first left edge; driving an optical detector to scan the first check pattern printed onto the medium and output a first check signal, the first check signal having a first extreme value of the overall scanning output during the optical detector scanning the first check pattern, a plurality of positions of the optical detector when outputting the first extreme value being defined as a plurality of first extreme positions; comparing among the plurality of first extreme positions and defining the leftmost of the plurality of first extreme positions as a first initial position; and adjusting a position adjustment value of the printhead by a first deviation value obtained from measuring the distance between the first initial position and the first predetermined reference point.

The present invention also provides a method for correcting a printer storing a first check pattern having a first right edge. The first right edge is separate by a reference point from a first predetermined distance. The method comprises steps of driving a printhead moving from right to left to print the first check pattern onto a medium, the printed first check pattern having a first right printing edge corresponding to the first right edge; driving an optical detector to scan the first check pattern printed onto the medium and output a first check signal, the first check signal having a first extreme value of the overall scanning output during the optical detector scanning the first check pattern, a plurality of positions of the optical detector when outputting the first extreme value being defined as a plurality of first extreme positions; comparing among the plurality of first extreme positions and defining the rightmost of the plurality of first extreme positions as a first initial position; and adjusting a position adjustment value of the printhead by a first deviation value obtained from measuring the distance between the first initial position and the first predetermined reference point.

The present invention also provides a printer capable of correcting printing deviation using one-way printing. The printer comprises a memory for storing a test pattern having a predetermined distance away from a reference point; a printhead for printing the test pattern stored in the memory as an actual pattern on a printing medium based on the test pattern when the printhead moves from a first end toward a second end; an optical detector for scanning the actual pattern in the same direction as the printhead moves; and a processor for determining an actual distance between the reference point and the actual pattern from the scanning result of the optical detector and updating a position adjustment value of the printhead according to the difference between the actual distance and the predetermined distance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of moving speed of a printhead and ink drop according to the prior art.

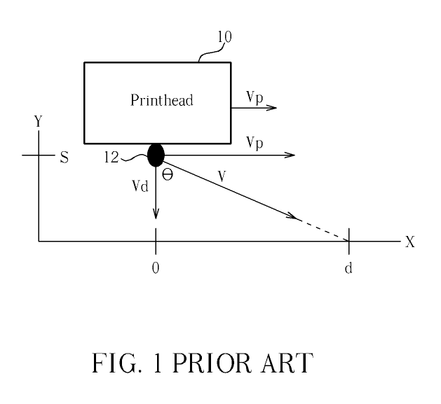

FIG. 2 is an illustration of a correlation diagram of the default position and actual position of an ink drop when the printhead prints bidirectionally according to the prior art.

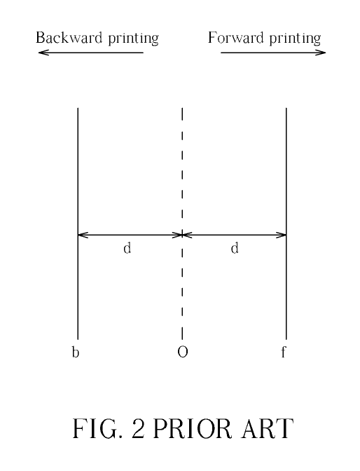

FIG. 3 is an illustration of a test pattern for adjusting bidirectional deviation according to the prior art.

FIG. 4 is an illustration of the actual output of the test pattern in FIG. 3.

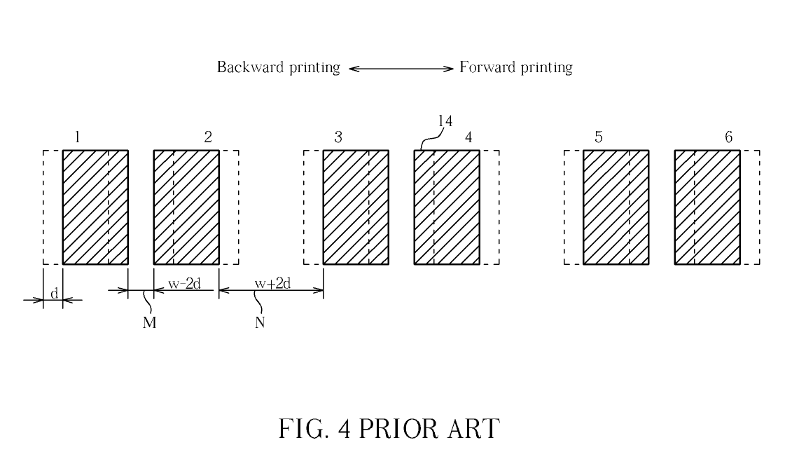

FIG. 5 is an illustration of an optical detector capable of moving with the printhead according to the prior art.

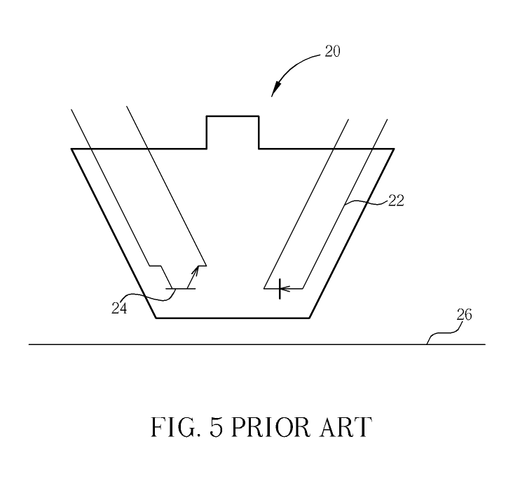

FIG. 6 is an illustration of a correlation diagram of the distance to the light reflection rate corresponding to the output in FIG. 4.

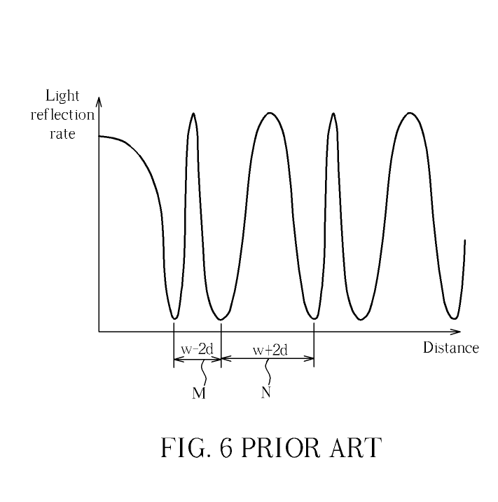

FIG. 7 is an illustration of an actual pattern corresponding to the test pattern in FIG. 3 printed by a jammed printhead according to the prior art.

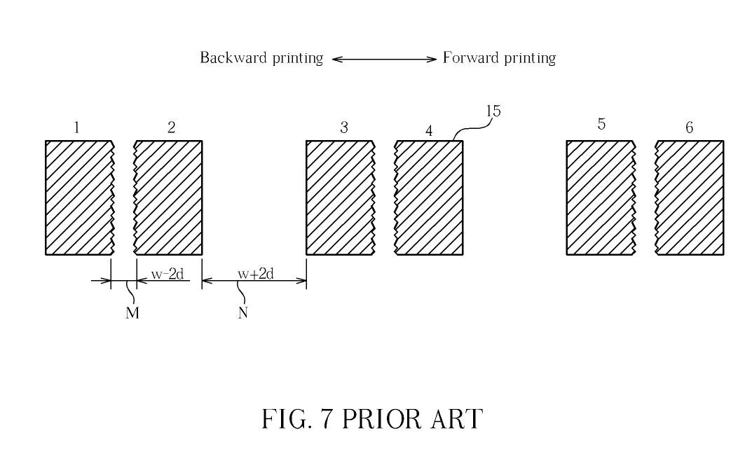

FIG. 8 is a flow chart of a method for correcting printing deviation of a printer using one-way printing according to the present invention.

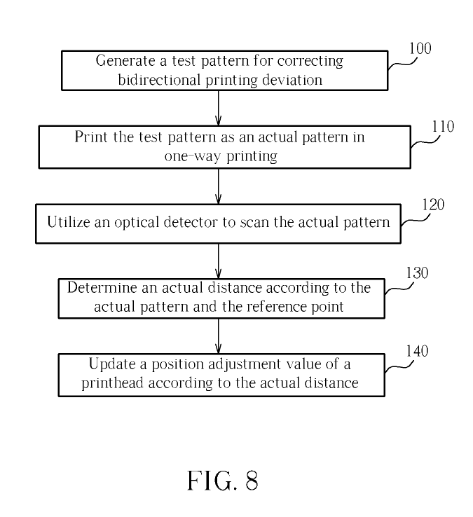

FIG. 9 is an illustration of an actual pattern outputted with forward printing according to the present invention.

FIG. 10 is an illustration of a correlation diagram of the distance to the light reflection rate corresponding to the output in FIG. 9.

FIG. 11 is an illustration of an actual pattern outputted with backward printing according to the present invention.

FIG. 12 is an illustration of a correlation diagram of the distance to the light reflection rate corresponding to the output in FIG. 11.

FIG. 13 is an illustration of a printer capable of correcting printing deviation using one-way printing according to the present invention.

### DETAILED DESCRIPTION

The present invention utilizes one-way printing to correct printing deviation of a printhead, solving inaccurate correction due to printhead jamming of the prior art. The method of the present invention has the following steps:

Step 100: generate a test pattern for correcting printing deviation, the test pattern stored in the memory of a printer and comprising a plurality of check blocks of the same size and each separate by the same distance as the width of each check block; a forward reference point lies away from the first check block for a forward predetermined distance;

Step 110: utilize a printhead to print the test pattern as an actual pattern onto a printing medium in one-way printing, which is printing the actual pattern in a direction from a first end of the printing medium toward a second end of the printing medium;

Step 120: utilize an optical detector to scan the actual pattern in the same direction as the printhead moves in Step 110 and generate a correlation diagram of a distance to the light reflection rate according to the scanning result;

Step 130: determine a forward actual distance between the first actual block and the forward reference point from the correlation diagram, the first actual block corresponding to the first check block; and

Step 140: update a position adjustment value of the printhead of the printer according to difference of the forward actual distance and the forward predetermined distance.

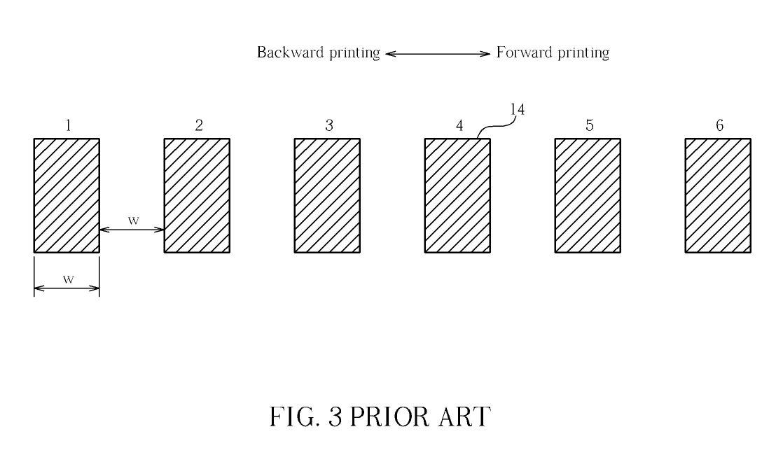

The present invention corrects the printing deviation of a printhead using one-way printing. The test pattern generated in Step 100 is shown as in FIG. 3, comprising a plurality of numbered check blocks 14. The wording “one-way printing” means the printhead prints the test pattern from the first end toward the second end, i.e. a forward direction from left to right in FIG. 3.

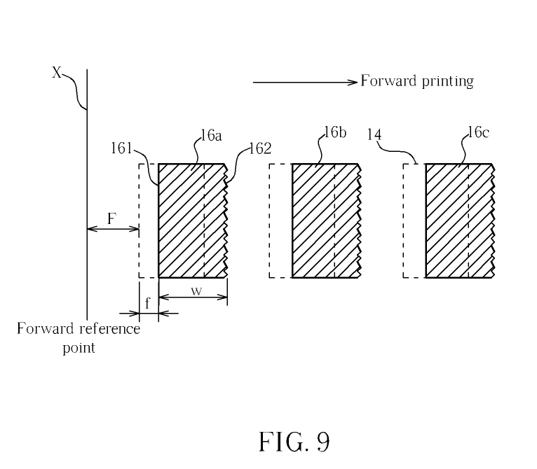

Each actual block 16 is printed with forward printing. As FIG. 9 shows, the printhead is driven to move and print from left to right, in which the dashed rectangles represent the positions of the check blocks 14 in the test pattern. The first check block 14 has a first left edge away from the forward reference point X with a forward predetermined distance F.

The black blocks are actual blocks 16 printed with forward printing. Viewing from the first end toward the second end, each actual block 16 has a left printing edge called a smooth edge 161 and a right printing edge called a deckle edge 162. Each of the position of the actual blocks 16 is away from each of the position of the check blocks 14 by a distance difference f due to the moving speed of the printhead when printing.

After outputting the actual pattern of FIG. 9 in Step 110, the optical detector scans the actual pattern of FIG. 9 in the same direction as the forward printing, i.e. the optical detector scans the actual pattern from left to right. The optical detector emits lights onto the actual pattern. Due to different shading level in the actual pattern, the optical detector receives lights with different reflecting energies from different areas. The optical detector then generates the corresponding check signals (the voltage signals) according to the lights received and a correlation diagram of the distance and the light reflection rate according to the position of the optical detector and the value of voltage signal as described in Step 120.

Since in the present invention, the required information is obtained through the optical detector detecting the absolute distance from the forward reference point X to the left printing edge, the smooth edge 161 of the actual block 16, the inaccuracy caused by the right printing edge, the deckle edge 162 of the actual block 16 in the prior art is effectively eliminated in the present invention.

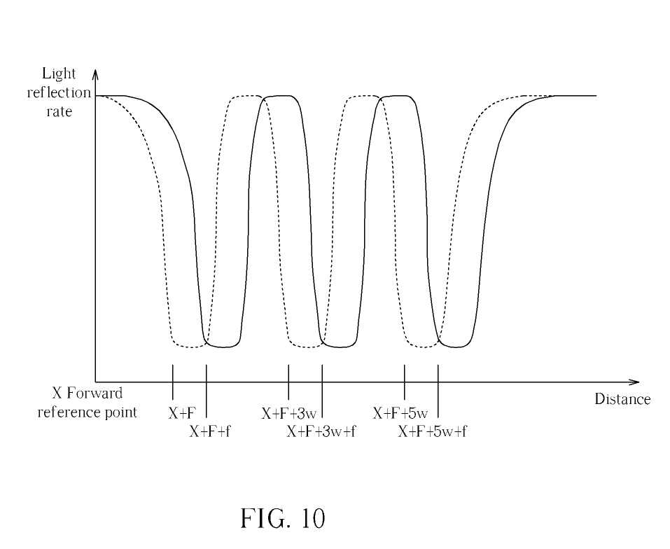

Please refer to FIG. 10. FIG. 10 is an illustration of a correlation diagram generated from the optical detector scanning the actual pattern in FIG. 9. The optical detector, usually with an effective sensing area, scans the actual pattern to determine the light reflection rate by the coverage of the optical detector on the actual block 16 of the actual pattern.

When scanning forwardly from the forward reference point X and before the effective sensing area of the optical detector reaches the left printing edge (the smooth edge 161) of the actual block 16, the optical detector detects maximum light reflection rate. Therefore, the curve in FIG. 10 remains at its maximum value from the beginning, the forward reference point X.

When the front end of the effective sensing area of the optical detector reaches and enters the first actual block 16, the energy of the reflected light gradually decreases because the overlapped surface between the effective sensing area and the first actual block 16 gradually increases.

When the rear end of the effective sensing area of the optical detector also reaches and enters the smooth edge 161 of the first actual block 16, the overlapped surface between the effective sensing area of the optical detector and the first actual block 16 reaches the maximum, so the check signal has the first extreme value, which first occurs at the position X+F+f in FIG. 10.

In the present invention, when the optical detector is forwardly scanning the first actual block 16, the plurality of positions where the minimum extreme value of the light reflection rate occur are all defined as the plurality of first extreme positions. Comparing among all the plurality of first extreme positions, the leftmost position is defined as the first initial position, or in a general sense, the position where the extreme reflection rate first occurs when the optical detector scans the actual pattern.

In FIG. 10, the first initial position is X+F+f, which is corresponding to the position where the rear end of the effective sensing area of the optical detector reaches the smooth edge 160 of the first actual block 16. Therefore, the position X+F+f in FIG. 10 is also the position where the minimum extreme value of the light reflection rate first occurs when the optical detector forwardly scans the first actual block 16 from the forward reference point X.

After the front end of the effective sensing area of the optical detector leaves the deckle edge 162 of the first actual block 16, the light reflection rate gradually increases, the overlapped surface between the effective sensing area of the optical detector and the first actual block 16 gradually decreasing, so the curve on the correlation diagram begins to rise.

The dashed curve in FIG. 10 is the correlation curve of the distance to the light reflection rate corresponding to the plurality of check blocks 14 in the test pattern under no deviation situation. The solid curve in FIG. 10 is the correlation curve of the distance to the light reflection rate corresponding to the plurality of actual blocks printed by the printhead based on the test pattern.

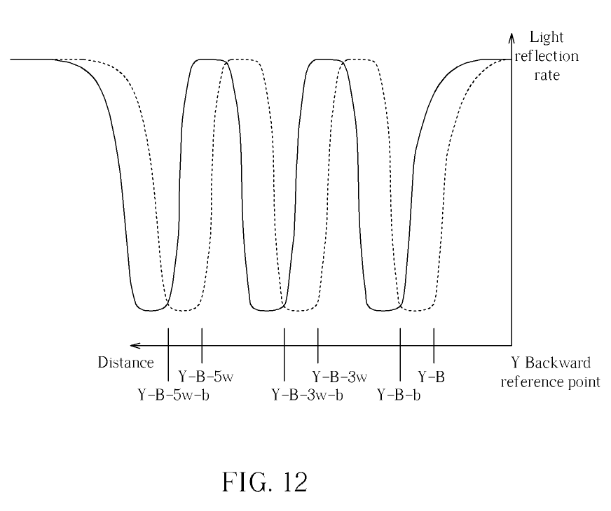

In FIG. 10, the forward actual distance between the first actual block 16 and the forward reference point X is F+f, calculated by the distance between the first initial position and the forward reference point X. However, the dashed rectangles in FIG. 10 stand for the positions of the check blocks 14 of the test pattern, where the first check block has a forward predetermined distance F with the reference point X. The present invention sets the position adjustment value as the difference of the forward actual distance and the forward predetermined distance in Step 140, i.e. (F+f)−F=f. The position adjustment value is taken as the forward adjustment value in forward printing. In other words, when the printer performs forward printing (printing in the direction from the first end toward the second end), a controller of the printer eliminates the position deviation caused by moving speed of the printhead when printing by adjusting the printing position of the printhead for a distance of f in advance. Since the determination of the position adjustment value f comes only from detecting the beginning boarder of the minimum light reflection rate, the first initial position in FIG. 10 (and FIG. 12), or the position adjustment value f is determined by the correlation between the effective sensing area of the optical detector and the smooth edge 161 of the actual block 16, irrelevant to the deckle edge 162 of the actual block 16, there is no place for obtaining an inaccurate printing deviation caused by measuring error of the optical detector that uses the information of the deckle edge 162 of the actual block 16 as in the prior art.

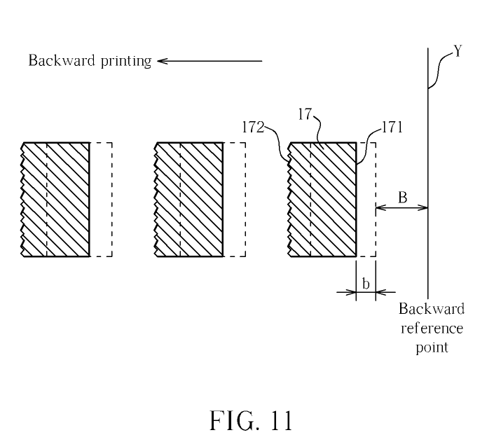

The backward printing and correction is like the forward printing. As FIG. 11 shows, the printhead moves and prints in the direction from the second end toward the first end, or a backward direction from right to left in FIG. 3 while the optical detector scans the actual pattern in FIG. 11 in the same backward direction as the printing direction, i.e. from right to left. The process to obtain the adjustment value relies on the right printing edge, or the smooth edge 171 of the actual block 17, irrelevant to the left printing edge, or the deckle edge 172, and the outcome is shown in FIG. 11 and FIG. 12. By separately correcting the printing deviations of forward printing and backward printing, the present invention avoids being influenced by the deckle edge cause by a defect printhead. On the other hand, separate correction in each direction allows the printhead to separately correct the speed deviation if the printhead has different moving speeds with forward printing and backward printing.

The method mentioned above is a preferred exemplary embodiment of the present invention. Since the test pattern comprises a plurality of check blocks 14 and the actual pattern comprises also a plurality of actual blocks 16 (or 17), if there are different printing deviations regarding different actual blocks 16, 17 when applying the correction method, the present invention can further take the average value of each deviation values of the actual blocks 16, 17 as the position adjustment value in one-way printing. For example, if the first actual block 16a has a first deviation value f1, the second actual block 16b has a second deviation value f2, and the third actual block 16c has a third deviation value f3, the position adjustment value is the average value of each deviation values, i.e. (f1+f2+f3)/3, when performing forward printing. The backward printing performed in FIG. 11 and FIG. 12 has a same way of skill. In such way, if the printer is incapable of maintaining a steady moving speed when performing one-way printing, the method of the present invention provides more effective and accurate ability to correction the printing deviation with such printer.

Although the method outputs the plurality of actual blocks 16, 17 to perform printing correction, simply one check block 14 in the test pattern is also practicable when using the method of the present invention. A forward reference point X and a backward reference point Y are separately located on both sides of the check block 14 and the printer separately outputs the single check block 14 with both forward printing and backward printing. The optical detector separately scans the actual block 16, 17 with both forward scanning and backward scanning and generates two correlation diagrams of the distance to the light reflection rate. Each single actual blocks 16, 17 corresponding to the single check block 14 with each reference points are calculated respectively and the calculated results are taken as the position adjustment values of the printhead in either directions.

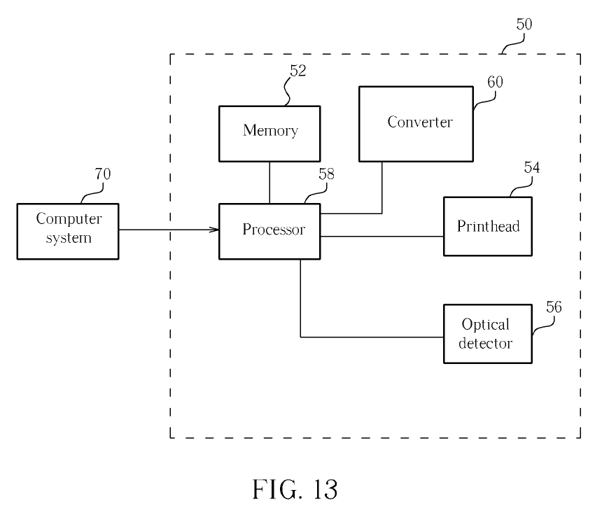

FIG. 13 is an illustration of a printer 50 capable of correcting printing deviation using one-way printing according to the present invention. The printer 50 comprises a memory 52, a printhead 54, an optical detector 56, a processor 58, and a converter 60. The processor 58 controls the operation of the printer 50. Before the printing job begins, the printing data is transmitted from a computer system 70 to the printer 50 and stored in the memory 52. When performing the one-way printing correction, the processor 58 generates a test pattern and stores it in the memory wherein the test pattern has a predetermined distance away from a reference point. Next the test pattern is printed as an actual pattern in one-way printing by the printhead 54, along with the optical detector 56 (usually fixed beside the printhead 54 and moving with the printhead 54) scanning the actual pattern in the same direction as the printhead prints the actual pattern. The converter 60 then converts the scanning result into a correlation diagram of the distance to the light reflection rate and stores the diagram in the memory 52. A correlation diagram of the distance to the light reflection rate of the test pattern exists in the memory 52 and the processor 58 calculates an actual distance between the actual pattern and the reference point and finally, the processor 58 updates the position adjustment value of the printhead 54 according to the difference between the actual distance and the predetermined distance. The difference between the actual distance and the predetermined distance is directly taken as the position adjustment value in the printer 50 of the present invention.

The printer of the present invention performs one-way printing for outputting a test pattern as an actual pattern having printing deviation. An optical detector then scans the actual pattern in the same direction as the actual pattern is outputted and transforms the scanning result into a correlation diagram of a distance to the light reflection rate. A one-way deviation amount can be obtained and taken as a position adjustment value of the one-way printing by comparing the curve in the correlation diagram with a reference point. The forward printing deviation and the backward printing deviation of the printer can be corrected respectively when confronting inaccurate correction due to printhead jamming.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting a position where an actual pattern is printed by a printhead, comprising steps of:
(a) defining a test pattern having a predetermined distance away from a reference point;
(b) printing the actual pattern onto a printing medium based on the test pattern when the printhead moves in a direction from a first end toward a second end;
(c) scanning the actual pattern by an optical detector moving in the same direction as the printhead moves in step (b);
(d) determining an actual distance between the reference point and the actual pattern from the scanning result of the optical detector; and
(e) updating the position where the printhead starts printing when the printhead moves from the first end toward the second end according to the difference between the actual distance and the predetermined distance.

2. The method of claim 1 wherein step (a) is generating the test pattern comprising a plurality of check blocks of the same size, each of the plurality of check blocks being separate by the same distance.

3. The method of claim 1 wherein step (c) is scanning the actual pattern by emitting lights onto the actual pattern by the optical detector and detecting the light reflection rate.

4. The method of claim 3 wherein step (c) is scanning the actual pattern by detecting the light reflection rate by the coverage of the optical detector on the check block of the actual pattern.

5. The method of claim 3, further comprising generating a correlation diagram of a distance to the light reflection rate according the detected light reflection rate.

6. The method of claim 3 wherein step (d) is determining the actual distance by measuring the distance between a first initial position of extreme reflection rate curve of the actual pattern and the reference point, wherein the first initial position of extreme reflection rate is the position where the extreme reflection rate first occurs when scanning the actual pattern in step (c).

7. The method of claim 1 wherein step (e) is updating a position adjustment value of the printhead by setting the position adjustment value as the difference between the actual distance and the predetermined distance.

8. A method for correcting a printer storing a first check pattern having a first left edge separate by a reference point from a first predetermined distance, the method comprising steps of:
driving a printhead moving from left to right to print the first check pattern onto a medium, the printed first check pattern having a first left printing edge corresponding to the first left edge;
driving an optical detector to scan the first check pattern printed onto the medium and output a first check signal, the first check signal having a first extreme value of the overall scanning output during the optical detector scanning the first check pattern, a plurality of positions of the optical detector when outputting the first extreme value being defined as a plurality of first extreme positions;
comparing among the plurality of first extreme positions and defining the leftmost of the plurality of first extreme positions as a first initial position; and
adjusting a position adjustment value of the printhead by a first deviation value obtained from measuring the distance between the first initial position and the first predetermined distance.

9. The method of claim 8, the printer further storing a second check pattern having a second left edge separate by a reference point from a second predetermined distance, the first check pattern and the second check pattern being separate by each other, the method comprising steps of:
driving a printhead moving from left to right to print the second check pattern onto the medium, the printed second check pattern having a second left printing edge corresponding to the second left edge;
driving an optical detector to scan the second check pattern printed onto the medium and output a second check signal, the second check signal having a second extreme value of the overall scanning output during the optical detector scanning the second check pattern, a plurality of positions of the optical detector when outputting the second extreme value being defined as a plurality of second extreme positions;
comparing among the plurality of second extreme positions and defining the leftmost of the plurality of second extreme positions as a second position; and
adjusting the position adjustment value of the printhead by the first deviation value and a second deviation value obtained from measuring the distance between the second position and the second predetermined distance.

10. The method of claim 9, further comprising:
adjusting the position adjustment value of the printhead by the average of the first deviation value and the second deviation value.

11. A method for correcting a printer storing a first check pattern having a first right edge separate by a reference point from a first predetermined distance, the method comprising steps of:
driving a printhead moving from right to left to print the first check pattern onto a medium, the printed first check pattern having a first right printing edge corresponding to the first right edge;
driving an optical detector to scan the first check pattern printed onto the medium and output a first check signal, the first check signal having a first extreme value of the overall scanning output during the optical detector scanning the first check pattern, a plurality of positions of the optical detector when outputting the first extreme value being defined as a plurality of first extreme positions;
comparing among the plurality of first extreme positions and defining the rightmost of the plurality of first extreme positions as a first initial position; and
adjusting a position adjustment value of the printhead by a first deviation value obtained from measuring the distance between the first initial position and the first predetermined distance.

12. The method of claim 11, the printer further storing a second check pattern having a second right edge separate by a reference point from a second predetermined distance, the first check pattern and the second check pattern being separate by each other, the method comprising steps of:
driving a printhead moving from right to left to print the second check pattern onto the medium, the printed second check pattern having a second right printing edge corresponding to the second right edge;
driving an optical detector to scan the second check pattern printed onto the medium and output a second check signal, the second check signal having a second extreme value of the overall scanning output during the optical detector scanning the second check pattern, a plurality of positions of the optical detector when outputting the second extreme value being defined as a plurality of second extreme positions;
comparing among the plurality of second extreme positions and defining the rightmost of the plurality of second extreme positions as a second position; and
adjusting the position adjustment value of the printhead by the first deviation value and a second deviation value obtained from measuring the distance between the second position and the second predetermined distance.

13. The method of claim 12, further comprising:
adjusting the position adjustment value of the printhead by the average of the first deviation value and the second deviation value.

14. A printer capable of correcting printing deviation using one-way printing, comprising:
a memory for storing a test pattern having a predetermined distance away from a reference point;
a printhead for printing the test pattern stored in the memory as an actual pattern on a printing medium based on the test pattern when the printhead moves from a first end toward a second end;
an optical detector for scanning the actual pattern in the same direction as the printhead moves; and
a processor for determining an actual distance between the reference point and the actual pattern from the scanning result of the optical detector and updating a position adjustment value of the printhead according to the difference between the actual distance and the predetermined distance.

15. The printer of claim 14 wherein the memory is for storing the test pattern comprising a plurality of check blocks of the same size, each of the plurality of check blocks being separate by the same distance.

16. The printer of claim 14 wherein the optical detector is for scanning the actual pattern by emitting lights onto the actual pattern and detecting the light reflection rate.

17. The printer of claim 16 wherein the optical detector is for scanning the actual pattern by detecting the light reflection rate by the coverage of the optical detector on the check block of the actual pattern.

18. The printer of claim 16, further comprising a converter for generating a correlation diagram of a distance to the light reflection rate according the light reflection rate detected by the optical detector.

19. The printer of claim 16 wherein the processor is for determining the actual distance by measuring the distance between a first initial position of extreme reflection rate curve of the actual pattern and the reference point, wherein the first initial position of extreme reflection rate is the position where the extreme reflection rate first occurs when the optical detector scans the actual pattern.

20. The printer of the claim 14 wherein the processor is for updating the position adjustment value of the printhead by setting the position adjustment value as the difference between the actual distance and the predetermined distance.
